(19) United States
(12) Patent Application Publication
(10) Pub. No.: US 2020/0090188 A1
(43) Pub. Date: Mar. 19, 2020

(54) AUTONOMOUS DATA EXCHANGE MARKETPLACE SYSTEM AND METHODS

(71) Applicant: Myndshft Technologies, Inc., Dover, DE (US)

(72) Inventors: Tyler Wince, Mesa, AZ (US); Ronnie Wince, Mesa, AZ (US); Stephen Meyers, Phoenix, AZ (US)

(21) Appl. No.: 16/569,521

(22) Filed: Sep. 12, 2019

Related U.S. Application Data
(60) Provisional application No. 62/732,977, filed on Sep. 18, 2018.

(51) Int. Cl. G06Q 30/02; H04L 9/32

(52) U.S. Cl. CPC G06Q 30/0201; H04L 9/32

(57) ABSTRACT

A data exchange marketplace through a private blockchain network is provided in association with a system facilitating automated data exchange and related methodology for effectuating the same.

### RELATED APPLICATIONS

This application claims the benefit of U.S. provisional patent application 62/732,977, filed Sep. 18, 2018, titled “Autonomous Data Exchange System and Methods,” the entirety of the disclosure of which is hereby incorporated by this reference.

### TECHNICAL FIELD

Aspects of this document relate generally to facilitation of a data exchange marketplace through a private blockchain network, related systems and methods, and associated exchange of data.

### BACKGROUND

As a consequence of advances in digital storage technologies, increasing storage capacity while reducing costs, along with improvements and innovations in data gathering technologies such as sensors and implementations of the Internet of Things (IOT), there is more data recorded today across a larger number of contexts than ever before. For example, people are wearing devices such as fitness trackers, and carrying mobile devices rife with sensors, all generating information to provide insights into fitness and health. Alongside these innovations that are yielding such a large cache of information are technologies that allow for deeper conclusions to be drawn from large, complex collections of observations. Tools such as artificial intelligence, machine learning, and data mining are able to take huge sets of data and find connections that may otherwise elude researchers

However, the insights provided by these tools are only as good as the data upon which the tools operate. While there is more data available today than ever before, data is often not readily available to parties that are interested in obtaining the data. Vast caches of data commonly generated by individuals, corporations, collective organizations, and other entities, as they function in an increasingly digitized existence where almost every activity leaves some sort of digital footprint, are frequently invisible to outside observers, commonly due to the demand and requirements of privacy protocols associated with the data. The needs of researchers and others interested in processing, analyzing and otherwise utilizing large stores of data are often at odds with popular desire and/or regulatory mandate for privacy. Additionally, the interactions between these different parties (entities who generate and/or store data, entities who recommend known data sets, and entities who desire access to the data) are regularly complicated by divergent business interests and/or a lack of trust. Moreover, decisions about the data that may need to be made by one party often require information held by another party and the common channels for requesting and providing such information can be frustratingly slow and unreliable. In addition, the process of determining what information about the data may be needed, requesting that information from another party, waiting for the information, receiving and evaluating it to finally render a decision often makes standard data exchange processes slow to a crawl, and provides many opportunities for problems and disagreements to arise.

Interacting parties participating in the potential exchange of data may each have their own internal systems for tracking the data and their part of the process, ensuring compliance with the law, and furthering their own interests. The differing and fragmented systems of the various parties regularly limit data sharing. Parties are often extremely reluctant to provide access to their internal systems, and instead provide the bare minimum information pertinent to potential data exchange and typically through inefficient channels. Additionally, parties operating in different technical spheres may have developed application-specific legacy computer and/or communication systems at great expense, over a long time, and even if all interest parties trusted each other and were open to the free exchange of information, the legacy systems in use are very frequently incompatible with each other, and full integration would require a great deal of effort at considerable cost.

### SUMMARY

According to one aspect, a method for providing a data exchange marketplace through a private blockchain network, wherein the method comprises creating a marketing data object in a world state associated with the blockchain network, wherein the marketing data object provides open access on the private blockchain network to details about a data object stored on a database. In addition, the method comprises adding descriptive data to the marketing data object, the descriptive data received from a peer associated with a provider, the descriptive data comprising a first hash of the data object. Moreover, the method comprises receiving a first transaction proposal on the private blockchain network, from a peer associated with a recommender approved on the private blockchain network, the first transaction proposal comprising a recommendation data object. Furthermore, the method comprises receiving an endorsed first transaction proposal response from each of, the peer associated with the provider and the peer associated with the recommender. Still further, the method comprises adding the recommendation data object to the marketing data object in the world state. Additionally, the method comprises receiving a second transaction proposal on the private blockchain network, from a peer associated with an acquirer approved on the private blockchain network, the second transaction proposal comprising an acquisition data object. Even further, the method comprises receiving an endorsed second transaction proposal response from each of, the peer associated with the provider and the peer associated with the acquirer, and also adding the acquisition data object to the marketing data object in the world state. What is more, the method comprises facilitating possession of a copy of the data object for the acquirer, wherein possession is only facilitated after the acquisition data object is added to the world state. Even further still, the method comprises facilitating validation, by the acquirer, that the copy of the data object has a second hash that identically matches the first hash of the data object contained in the marketing data object of the world state. Yet still further, the method comprises modifying at least one of a credit data object associated with the provider, a credit data object associated with the recommender, and a credit data object associated with the acquirer.

Particular aspects of the method for providing a data exchange marketplace through a private blockchain network include the recommendation data object comprising a recommendation from the recommender that the data associated with the data object is valid. The acquisition data object includes information about who the acquirer is and what the acquirer plans to do with the data, once the data is possessed by the acquirer. The database storing the data object resides outside of the blockchain network. The endorsed second transaction proposal response is facilitated by a smart contract executable by at least the peer associated with the provider, wherein the smart contract provides a governing protocol for automatic implementation of a decision-making process determining whether the acquirer meets qualifications permitting possession of the data object. The qualifications are associated with a data use policy dictating who may possess the data object based on how the data associated with the data object is intended to be used by the one who possesses the data object. The smart contract evaluates the acquisition data object to determine qualifications of the acquirer and facilitate effectuation of the endorsed second transaction proposal response. The modification of the at least one credit data object is listed on an immutable transaction history of the blockchain network as having occurred. The credit data object pertains to a tally of points associated with an internal point system of the blockchain network, wherein the internal point system corresponds to transactions effectuated by entities associated with the blockchain network. The credit data object pertains to a benefit inured to at least one of the provider, the recommender, and the acquirer. The benefit is an allotment of points associated with an internal point system of the blockchain network, wherein the internal point system corresponds to transactions effectuated by entities associated with the blockchain network. The benefit is an allocation of preferred access to data resources associated with the blockchain ledger. The benefit is apportioned between at least two of the provider, the recommender, and the acquirer.

According to another aspect a method for providing a data exchange marketplace through a private blockchain network, wherein the method comprises creating a marketing data object in a world state associated with the blockchain network, wherein the marketing data object provides open access on the private blockchain network to details about a data object stored on a database. Moreover, the method comprises adding descriptive data to the marketing data object, the descriptive data received from a first peer associated with a first entity, the descriptive data comprising a first hash of the data object. In addition, the method comprises receiving a first transaction proposal on the private blockchain network, from a second peer associated with a second entity approved on the private blockchain network, the first transaction proposal comprising a recommendation data object. Furthermore, the method comprises receiving an endorsed first transaction proposal response from each of, the first peer associated with the first entity and the second peer associated with the second entity. Still further, the method comprises adding the recommendation data object to the marketing data object in the world state. Additionally, the method comprises receiving a second transaction proposal on the private blockchain network, from a third peer associated with a third entity approved on the private blockchain network, the second transaction proposal comprising an acquisition data object. What is more, the method comprises receiving an endorsed second transaction proposal response from each of, the first peer associated with the first entity and the third peer associated with the third entity. Even further, the method comprises adding the acquisition data object to the marketing data object in the world state. Yet further still, the method comprises facilitating possession of a copy of the data object for the third entity, wherein possession is only facilitated after the acquisition data object is added to the world state. Still even further, the method comprises facilitating validation, by the third entity, that the copy of the data object has a second hash that identically matches the first hash of the data object contained in the marketing data object of the world state.

Particular aspects of the method for providing a data exchange marketplace through a private blockchain network include facilitating an operation upon data associated with the data object, wherein manifestation of occurrence the operation upon the data is placed in sequence and added to an immutable transaction history of the blockchain network. The operation includes aggregating the data associated with the data object into a nicely formatted set. The method further comprises modifying at least one of a credit data object associated with the first entity, a credit data object associated with the second entity, and a credit data object associated with the third entity.

According to yet another aspect a method for providing a data exchange marketplace through a private blockchain network, wherein the method comprises creating a marketing data object in a world state associated with the blockchain network, wherein the marketing data object provides open access on the private blockchain network to details about a data object stored on a database. Additionally, the method comprises adding descriptive data to the marketing data object, the descriptive data received from a peer associated with a provider, the descriptive data comprising a first hash of the data object. Moreover, the method comprises receiving a transaction proposal on the private blockchain network, from a peer associated with an acquirer approved on the private blockchain network, the second transaction proposal comprising an acquisition data object. Furthermore, the method comprises receiving an endorsed transaction proposal response from each of, the peer associated with the provider and the peer associated with the acquirer. Still further, the method comprises adding the acquisition data to the marketing data object in the world state. What is more, the method comprises facilitating possession of a copy of the data object for the acquirer, wherein possession is only facilitated after the acquisition data object is added to the world state. Even further, the method comprises facilitating validation, by the acquirer, that the copy of the data object has a second hash that identically matches the first hash of the data object contained in the marketing data object of the world state. Yet further still, the method comprises modifying at least one of a credit data object associated with the provider and a credit data object associated with the acquirer.

Particular aspects of the method for providing a data exchange marketplace through a private blockchain network include receiving a transaction proposal on the private blockchain network, from a peer associated with a recommender approved on the private blockchain network, the transaction proposal, from the peer associated with the recommender, including a recommendation data object. The method further comprises receiving an endorsed transaction proposal response from each of, the peer associated with the provider and the peer associated with the recommender. The method further comprises adding the recommendation data object to the marketing data object in the world state. The credit data object pertains to a benefit inured to at least one of the provider, and the acquirer. The benefit is remuneration to the provider, at least following the addition of descriptive data to the marketing data object.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1 is a schematic view of a data exchange marketplace system;

FIG. 2 is a schematic view of a transaction flow within a data exchange marketplace method;

FIG. 3 is a schematic view of a data exchange marketplace system comprising multiple channels;

FIG. 4 is a schematic view of two organizations within the data exchange marketplace system engaging in peer-to-peer communication;

FIG. 5 is a schematic view of multiple blockchain networks being bridged by a manager organization within a data exchange marketplace system; and

FIG. 6 is a schematic diagram of a specific computing device that can be used to implement the methods and systems disclosed herein, according to one or more embodiments.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Contemplated herein is a system and method for a data exchange marketplace that is built upon, and automated through, a private blockchain network. The various parties involved in the data exchange marketplace are represented within this network as entities, all sharing a ledger that provides an immutable record of transactions, and a world state holding shared information that can be trusted, even if there is no trust between the parties themselves. Much of the inter-entity interactions and intra-entity operations are automated through the use of smart contracts, which greatly speed up processes that have traditionally been very slow and inure a level of trust to the entire process. Given the importance of data access and data sharing in an increasingly interconnected global environment those delays and the lack of trust can be, at best, frustrating, and can be extremely costly. Embodiments of a data exchange marketplace system may be applied, inter alia, to a data marketplace, wherein individuals, companies, organizations, and other various entities within the private blockchain network may be able to obtain a benefit associated with providing certain data in their possession for the recommendation and/or access by other entities within the blockchain network, with confidence in who they are providing access to, what the certain data will ultimately be used for, and what specific information about the certain data they are providing.

Additionally, by maintaining the immutable ledger associated with the blockchain network, parties are able to see a timeline of transactions, rather than simply having access to information regarding the current state, as is often the case in conventional systems. This additional information may facilitate the detection of patterns and help reduce waste, fraud, inaction, misuse, and breaches of confidentiality that tend to slip through the cracks in conventional data exchange systems and networks. The ledger may also provide material to quickly build artificial intelligence and machine learning models.

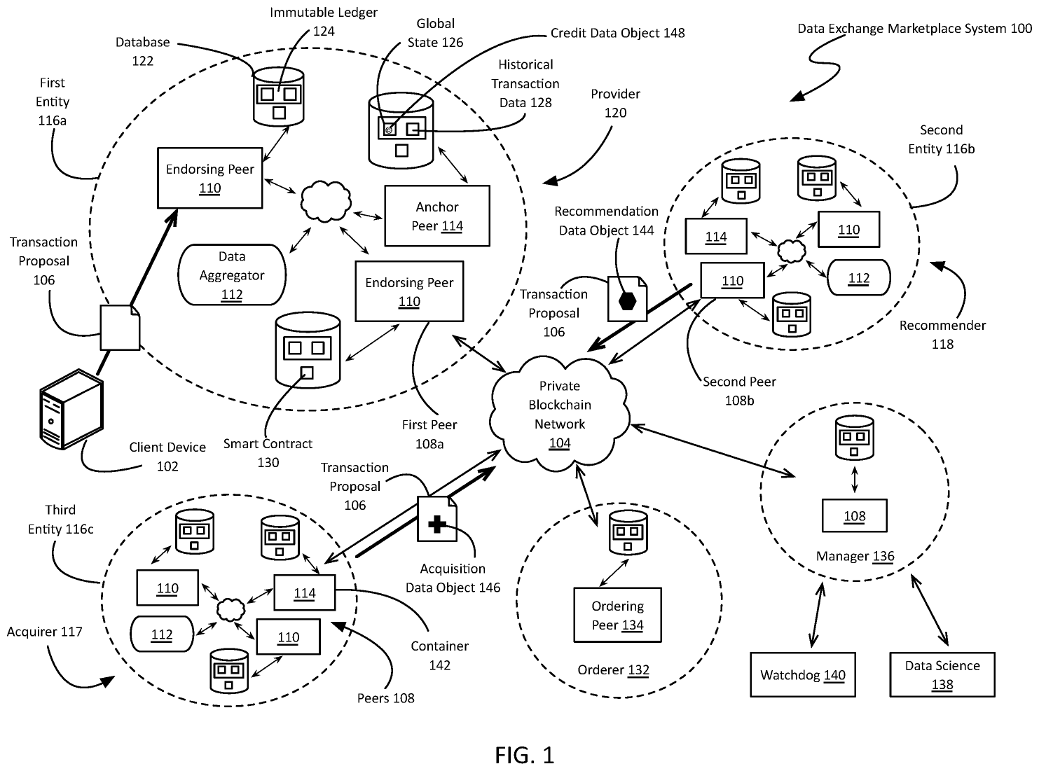

FIG. 1 shows a schematic view of a non-limiting example of a data exchange marketplace system 100 (hereinafter DEM system 100). The DEM system 100 is built upon a private blockchain network 104 through which a plurality of entities involved in data provision, recommendation, acquisition and sharing or having an interest in data provision, recommendation, acquisition and sharing, can interact with efficiency and trust. Each of these parties is represented within the blockchain network 104 by an entity 116.

An entity 116 may range in size and complexity from an individual person, a group of collaborating researchers, a corporation, or even to a large university. Some entities represent data providers 120, meaning a party that is seeking to provide data, wherein the data may possibly be provided in association with a data exchange marketplace 100 and corresponding private blockchain network 104. Examples include, but are not limited to, individuals, companies, hospitals, doctor offices, clinics, laboratories, imaging facilities, pharmacies, treatment centers, research departments, universities, and the like. Other organizations may represent recommenders 118, meaning a party that recommends data, wherein the knowledge of the data is accessible via a world state of the private blockchain network 104. Examples include, but are not limited to, researchers, universities, government bodies, companies, noted scientists, scientific bodies, and the like. Still other entities represent data acquirers 117, meaning a party that is seeking to acquire data, wherein the data may possibly be acquired in association with interactions with a data exchange marketplace 100 and corresponding private blockchain network 104. Examples include, but are not limited to, companies, universities, researchers, research organizations, insurance companies, Medicaid, pharmaceutical rebate programs, hospitals, laboratories, and the like. In some embodiments, a DEM system 100 may comprise organizations representing multiple providers 120, multiple recommenders 118, and/or multiple acquirers 117.

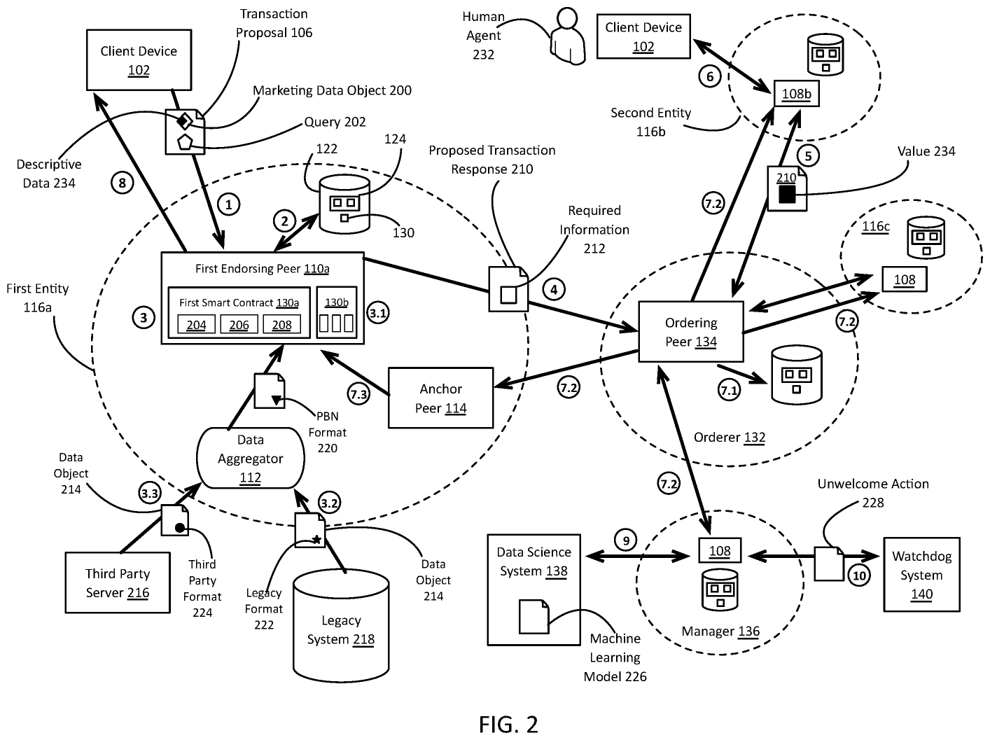

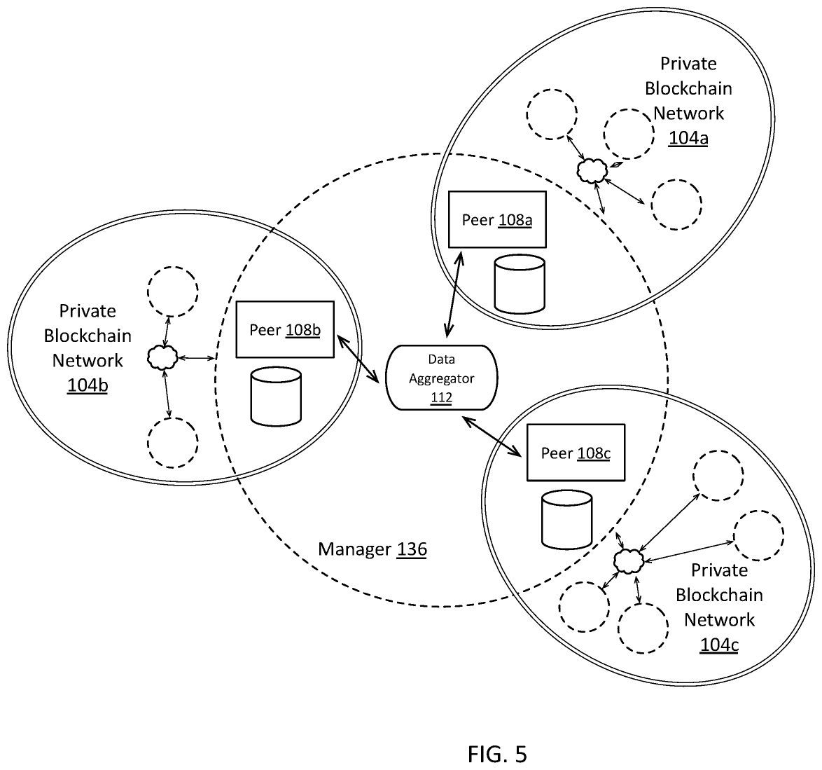

Additionally, according to various embodiments, the DEM system 100 may also include special organizations, such as a manager organization 136 and an orderer organization 132. An orderer organization 132 comprises one or more ordering peers 134 and is responsible for verifying proposed transactions, ordering them into blocks, and disseminating updates to the immutable ledger throughout the blockchain network 104. According to various embodiments, a manager organization 136 may administer the blockchain network 104, bridge multiple networks, and/or provide additional functionality by operating on the immutable ledger 124 with systems such as a data science system 138 or a watchdog system 140, both of which will be discussed further, below. The orderer 132 will be discussed in greater detail with respect to FIG. 2. The manager organization 136 will be discussed in greater detail with respect to FIGS. 2 and 5.

As shown, each entity 116 comprises one or more peers 108. A peer 108 acts as a representative for the entity 116 within the private blockchain network 104 (hereinafter BCN 104). These peers 108 are used to obtain and share information with other entities 116 within the BCN 104. According to various embodiments, a peer 108 may be implemented as a discrete unit of computer hardware, such as a server, or may be implemented in an abstracted or even distributed environment, such as a virtual machine, a container, a pod within a cluster, and the like. Specialized types of peers 108 will be discussed below.

As mentioned above, the entities 116 interact with each other through a private blockchain network (PBN) 104. A private blockchain network 104 is a technical infrastructure that provides immutable ledger and smart contract services. Transactions and access is limited to peers having proper permissions to participate in the network. In some embodiments, membership services are managed by one or more certificate authorities associated with each entity that issue public/private key cryptographic certificates to certify their peers, and that the peers use to endorse network messages (e.g. proposed transactions, proposed transaction responses, etc.). The use of a private network prevents unauthorized access, rogue entities, or violations of policies agreed upon by member entities and associated parties.

In some embodiments, entities 116 will have more than one peer 108, which may provide redundancy in case of failure, and may be used to further partition certain types of information. As shown in FIG. 1, each peer 108 is connected to a database 122 within the entity. In some embodiments, one peer 108 may share a database 122 with another peer 108, but typically each peer 108 has its own database 122. Said database 122 may be implemented on the same hardware as the peer 108, or may be a separate hardware object that the peer 108 is coupled to, either directly or through a larger network.

The databases 122 are used to store one or more immutable ledgers 124, which comprises a world state 126 and a historical transaction data 128. In the context of the present description, a world state 126 is the current snapshot of the known “universe” within a particular PBN 104. It is the latest update for all the information available within the network 104, or that has been shared through the network 104. It does not contain historical data. For example, the world state 126 may contain information including but not limited to the name of a data set or machine learning (“ML”) model, and associated metadata such as size, feature names, column names, shape of the data, a summary (e.g. average values, other statistics, etc.), who owns the data set, who has previously purchased it, how the data was gathered (e.g. self-reported, gathered in clinical setting, etc.), and the like. In some embodiments, the world state may also indicate one or more recommendations that have been made on the data or ML model. In some embodiments, the world state 126 may exist with a database structure.

The historical transaction data 128 is the transactional log of all operations within the blockchain network 104, as is known in the art. Each database 122 may maintain a copy of the historical transaction data 128, which tracks transactions, their results, and when they happened, across the network. Continuing with the example above, while the world state 126 may show that an ML model is available for evaluation, the historical transaction data 128 may show that 5 weeks ago the ML model did not correspond to a particular data set, and that only in the last 3 days has the particular data set been applied to the ML model. According to various embodiments, the historical transaction data 128 may contain any information that has been shared between entities 116, or requests that were made (even if they were not taken to completion). The world state 126 can be recreated using the information contained in the historical transaction data 128. Peers 108 within an entity 116 can share data to reconstitute a ledger, or the ledger may be requested from the orderer organization 132. The orderer 132 will be discussed in greater detail with respect to FIG. 2. According to various embodiments, the historical transaction data 128 may be stored as a flat file, in contrast to the database structure of the world state 126.

Furthermore, the blockchain ledger 124 is immutable, as is known in the art (e.g. chained hashing within blocks to prevent tampering, etc.). The use of an immutable shared ledger 124 to record the information transactions between the entities 116 allows parties that might not have much trust in each other to move forward with confidence in the ledger 124, knowing that the other entities 116 can be held to the things they “said” over the blockchain network 104.

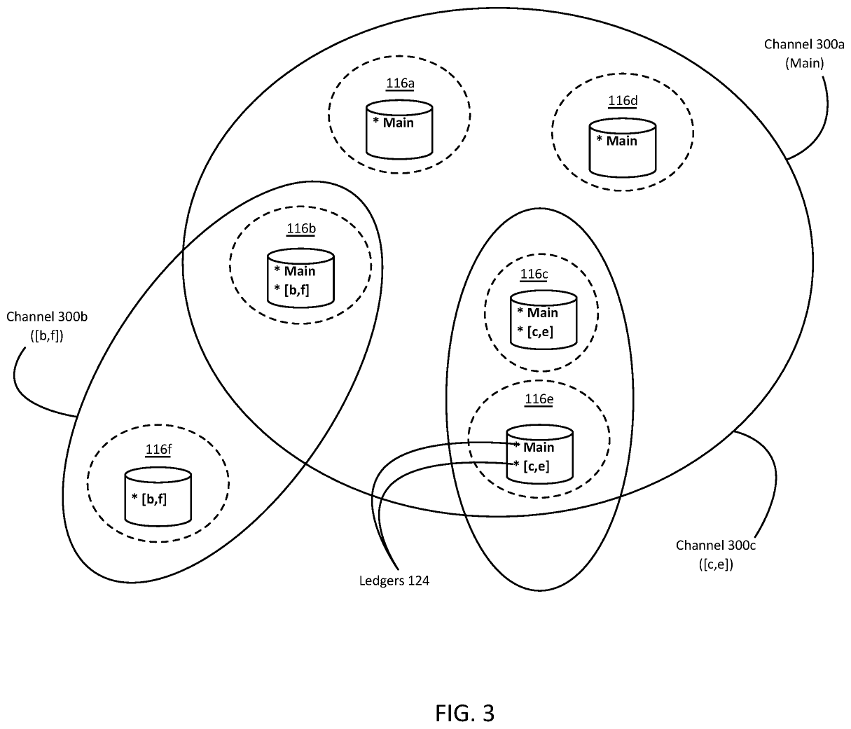

The database 122 may also contain one or more smart contracts 130, which will be discussed in greater detail with respect to FIG. 2. In other embodiments, the smart contracts 130 may be localized in the endorsing peers 110, discussed below. Furthermore, the operation of the DEM system 100 with respect to the ledger 124 and the blockchain network 104 will be discussed in greater detail with respect to FIG. 2. In some embodiments, databases 122 may have multiple ledgers 124, when the coupled peer 108 is participating in more than one channel 300. Channels 300 will be discussed in greater detail below with respect to FIG. 3.

According to various embodiments, an entity 116 may be associated with, or make use of, more than one kind of peer 108. As shown in FIG. 1, an entity 116 may have an anchor peer 114. An anchor peer 114 is the first point of contact with the rest of the network 104 when a ledger update is sent out from the orderer 132. The anchor peer 114 receives these updates and disseminates them to the other peers 108 within or otherwise associated with the entity 116.

Each entity 116 may include at least one endorsing peer 110. In the context of the present description, an endorsing peer 110 is a peer 108 that hosts or has access to at least one smart contract 130, and is capable of endorsing proposed transactions 106 (e.g. using a cryptographic certificate issued by the parent organization 116). Proposed transactions 106 and smart contracts 130 will be discussed in greater detail with respect to FIG. 2, below. In some embodiments, all peers 108 within an entity 116 may be endorsing peers 110, while in others some of the peers 108 may be reserved to perform validation or maintain ledger status. As an option, a peer 108 may temporarily be given or lose “endorsing peer” status, depending on requirements of the DEM system 100 (e.g. reconstituting ledgers 124 after data loss, etc.).

In operation, an endorsing peer 110 is able to provide a simple yes or no on a proposed transaction 106 (e.g. an information request, etc.). If the peer 108 is able to fulfill a smart contract 130 related to the proposed transaction 106, it may “sign” the transaction and pass it to the orderer 132, as will be discussed in greater detail with respect to FIG. 2. In some embodiments, the signature of an endorsing peer 110 may be accomplished using a digital certificate.

It should be noted that the endorsement of a proposed transaction 106 by a peer 108 does not indicate an adjudication or result. Rather, endorsement simply indicates that the requested aspect of a smart contract 130 was able to be fulfilled. For example, a peer 108 belonging to a recommender 118 may receive a proposed transaction 106 from a provider 120 regarding authorization for endorsing a recommendation. The smart contract 130 that handles such proposed transactions 106 may examine the ledger 124 and find that all the needed information of an associated recommendation data object 144 is available, but may determine that the procedure is not authorized because it the recommendation is superfluous and not needed. The endorsing peer 110 handling this proposed transaction 106 would sign the result, indicating the smart contract 130 was able to fulfill its requirements to perform its job, and the signed result, “denied”, is returned to the endorser 110.

According to various embodiments, the peers 108 do not get bogged down in the details of a transaction, but instead leave that to the smart contracts 130 which they execute and ensure have everything that is needed to do their job. If they can do their job, the peer 110 will sign the result. If they cannot do their job, the peer 110 will not sign the result, according to various embodiments. In some embodiments, each endorsing peer 110 in an entity 116 may store, or have access to, all smart contracts 130 that it may deal with (those executed by the entity 116 and possibly those from other entities 116 that may request information). In other embodiments, the smart contracts 130 may be distributed among the peers 108 of an entity 116 in a manner that spreads the computational or network load evenly, or based upon other criteria.

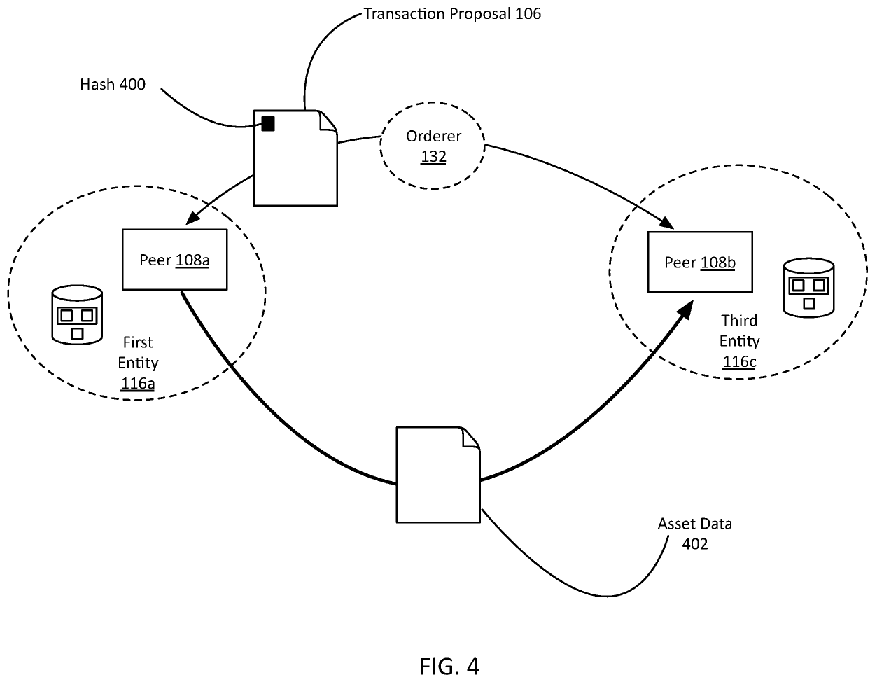

As shown in FIG. 1, each entity 116 may also be associated with a data aggregator 112. In the context of the present description, a data aggregator 112 is a tool that allows for the collection, reformatting, and consolidation of data. The data aggregator 112 may stand as an interface between proprietary or legacy systems used by an entity 116 (e.g. internal records system, inventory system, accounting system, patient records system, electronic medical record/electronic health record (EMR/EHR) systems, fitness tracking system of an app on a smart phone, etc.) and the peers 108 connected to the blockchain network 104. The data aggregator 112 allows an entity 116 to become part of the blockchain network 104 and participate in the DEM system 100 quickly, and without requiring a complete overhaul of systems that may have been the result millions of dollars and years of effort. Each entity 116 may use different internal systems, and the data aggregator 112 provides a way to quickly place all of the shared data in a common format. The use of a consistent format facilitates automation of the system, as well as other features such as private peer-to-peer information sharing, which will be discussed in greater detail with respect to FIG. 4, below. In some embodiments, the data aggregator 112 may employ some form of automation, while other embodiments may make use of artificial intelligence, to recognize patterns, formats, and data types, as well as reduce faulty reads. Furthermore, in some embodiments, a data aggregator 112 may be used to bridge multiple blockchain networks 104, which will be discussed with respect to FIG. 5, below.

As shown in FIG. 1, the DEM system 100 may also comprise one or more client devices 102. In the context of the present description, a client device 102 is a device configured to use an interface through which individuals or systems may interact with the DEM system 100. Exemplary interfaces include, but are not limited to, websites or a web interface, APIs, mobile and/or desktop applications, and the like. A client device 102 may be any of various computing platforms, such as mobile devices, desktop devices, and embedded systems. Client devices 102 may use a variety of interfaces, such as an application or website, or even a phone-based system with voice recognition.

As will be discussed with respect to FIG. 2, a client device 102 may be the source of a transaction proposal 106. In some embodiments, a client device 102 may be affiliated with an entity 116 or a party or organization that the entity 116 represents within the PBN 104. For example, a desktop computer running an interface application used by researchers of a university. In other embodiments, a client device 102 may be operated outside of an entity 116, but still be related to an entity 116 (i.e. it communicates with a peer 108 associated with an entity 116). For example, an app on a smart phone that allows researchers to access a catalog of available data sets maintained by other entities, but pertinent to research done by the university. The client device 102 may help facilitate and interactive means of acquiring and even purchase desirable data.

FIG. 1 shows the entities 116 connected to each other through a provisioned blockchain network 104. According to various embodiments, the DEM system 100 is built upon a blockchain network 104 through which the various entities 116 interact. While the majority of the discussion below will be in the context of blockchain networks, it should be understood that the blockchain network 104 may be implemented in various ways, depending upon other characteristics of the DEM system 100 discussed above. For example, in an embodiment where each entity 116 hosts and maintains their own hardware functioning as peers 108, the blockchain network 104 may be implemented on a WAN, such as the Internet. In another embodiment, where entities 116 interface their internal systems with the DEM system 100 through data aggregators 112, and the data aggregators 112, peers 108, and other system elements are hosted by a managing party, the blockchain network 104 may be implemented through the internal network of a datacenter, or the internal messaging of a cluster or other distributed computing environment, or even within a single device. While the following discussion will focus on how the entities 116 interact with each other and the blockchain network 104, those skilled in the art will recognize that the physical implementation of the DEM systems 100 contemplated herein, and the methods they employ, may be adapted to a variety of hardware and network architectures.

Before proceeding, it is important to address the potential divergence between the function of the DEM system 100, and its implementation. For example, as depicted in FIG. 1, the concept of entities 116 is being used to partition peers 108, databases 122, smart contracts 130, and the like, between different entities. Such a partitioning is functional, but not necessarily physical. For instance, in some embodiments, the peers 108 and databases 122 for different entities 116 may be maintained by a single party or organization. In some embodiments, the elements shown in FIG. 1 and discussed below may be implemented in a container 142 or virtual machine environment, and the elements for more than one entity 116 may be hosted on the same device, cluster, or datacenter (i.e. a shared hardware environment).

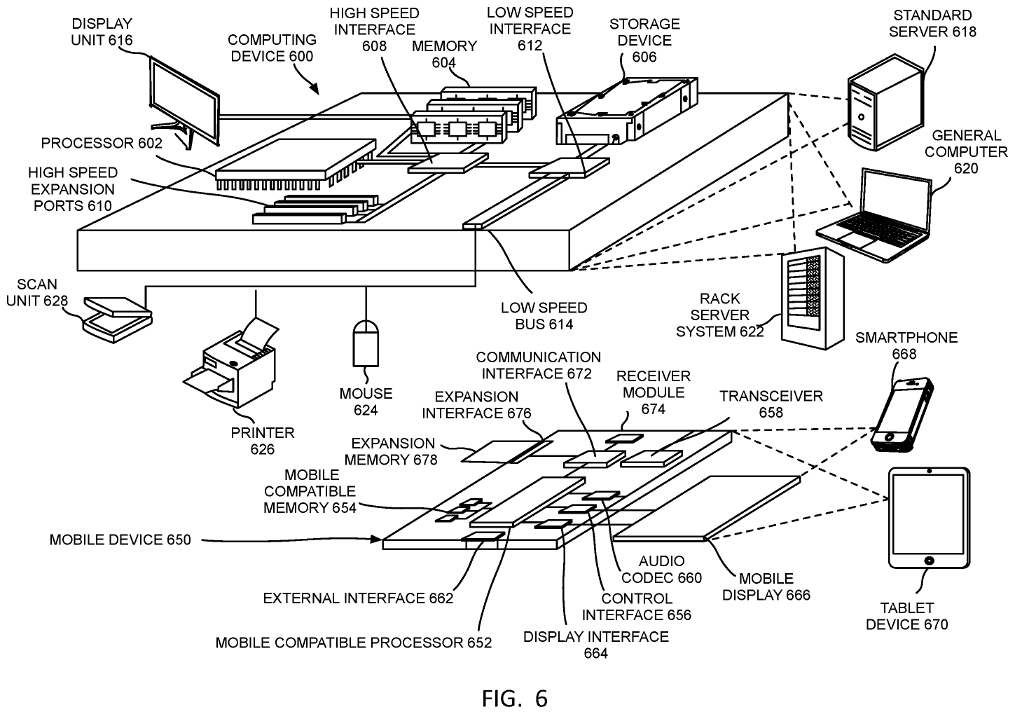

For example, in one embodiment, peers 108 belonging to multiple entities 116 may be implemented as containers 142. As an option, these containers 142 may exist within the same shared hardware environment, such as the specific computing device 600 of FIG. 6.

In other embodiments, entities 116 may maintain their own hardware as related to the DEM system 100. In still other embodiments, a combination may be utilized, where entities 116 may continue to host and manage an internal, possibly proprietary system that interfaces with the blockchain network 104 through elements (e.g. peers 108, data aggregators 112, etc.) dedicated to that entity 116 but hosted by another party, such as the manager organization 136. Such an implementation may be advantageous as it may make it easier for an entity 116 to join and participate in the network 104 and benefit from the systems and methods contemplated herein.

FIG. 2 is a schematic view of an exemplary transaction flow for a non-limiting example of a method for facilitation of data exchange in association with a DEM system 100. Though not explicitly shown in FIG. 2, all of the transactions between entities 116 are occurring through a private blockchain network 104, and communications between peers 108 and other elements within an entity 116 and elements outside of an entity 116, such as a third-party server 216, occur through conventional networks and protocols, as is known in the art. However, it should be noted that these transactions are non-limiting examples.

The process may begin with the receipt of a transaction proposal 106 from a client device 102. See circle 1. A transaction proposal 106 is a formalized set of input parameters for a transaction within the DEM system 100. Exemplary transactions include, but are not limited to, making some sort of request (e.g. requesting an adjudication from another entity 116, etc.), the submission of patient information during onboarding, the updating of information regarding patient status, or even simply reading information from the shared immutable ledger 124. As previously stated, the client device 102 interacts with a peer 108 from an entity 116 with which it is associated. For the example shown in FIG. 2, the client device 102 may be a computer used by a researcher to add description data to a marketing data object in a world state that provides open access on the blockchain network to details about a data object stored on a database. The database storing the data object can reside outside of the blockchain network. The data object pertains to the data being brokered for exchange via the data exchange marketplace system. A data object could be a data set from an individual (such as fitness data logged over time by the individual's smart watch) or it could be an aggregated set of data from many individuals (such as social behaviors tracked with regard to thousands of college students). Data associated with a data object does not have to be prepackaged, grouped, arranged or culled in any particular manner. Rather, the data can be built to order based on needs from what is known to entities via access to the world state. Moreover, a data object could be a machine learning model developed for a data set that could also be made known and available for entities within the blockchain to use, view, sponsor or recommend.

The marketing data object may include information and descriptive data 234 about the data object, such as meta data that includes details (demographic or otherwise) about the data object, a summary of the data object, an ML model that is usable for operating upon the data object, recommendations about the veracity of the data object, and/or updates showing how many times the data object has been exchanged, sold, used, modified, and/or recommended. Descriptive data 234 associated with a marketing data object may include a hash, such as a first hash or second hash, wherein the hash is derived from an algorithmic function that converts data associated with the principal data object into a unique and encrypted output of a fixed length, and/or other like descriptive data 234.

According to various embodiments, a transaction proposal 106, such as a first transaction proposal or a second transaction proposal, may comprise a marketing data object 200 and a query 202, when the transaction or interaction with the DEM system 100 is related to a particular entity providing, recommending or acquiring data. A transaction proposal 106 may also pertain to a particular entity that is managing or maintaining aspects of blockchain network functionality. In other words, a transaction proposal 106 could be crafted to obtain information or perform an action that is not specific to any particular data object and that would not necessarily contain a marketing data object 200.

In some cases, a client device 102 may form the transaction proposal 106 with a marketing data object 200 specifying descriptive data 234 having a unique identifier that is particular to the entity 116 with which the client device 102 is associated (e.g. the first entity 116a of FIG. 2, etc.). For example, a client device 102 in a university might use that university's internal research department reference number as descriptive data 234 in a marketing data object 200, even though that university's internal department reference number may be useless to other entities 116 within the DEM system 100. In such cases, the marketing data object 200 may be used to pull a universally agreed upon set of identifying information from within the first entity 116a before continuing to transact with other entities 116 concerning that internal research department. Such a situation may be dealt with through a thoughtfully crafted smart contract 130, as will be discussed in greater detail, below.

In the context of the present description and the claims that follow, a query 202 is a determination of unknown value to be made by an entity 116 within the PBN 104. The query 202 may be thought of as the question that is represented by a field (i.e. the determination) that is empty or valueless. The transaction proposal 106 is a set of input parameters, and the specification of a field that does not have a value can trigger the execution of a smart contract 130 that has been defined for the specific purpose of filling in that field. Exemplary queries 202 include, but are not limited to, a purchase request from an acquirer for a data set or ML model associated with a data object and identified by a market data object accessible with a world state of the blockchain network, a request to recommend data pertaining to a data object, and/or a request for an operation to be performed on a known data object, such as services of a data cleaner, and the like.

According to various embodiments, a transaction proposal 106 having a query 202 can be said to originate from a first entity 116a and seek a determination from a second entity 116b within a DEM system 100 comprising a plurality of entities 116 that include recommenders 118, providers 120, acquirers 117, and other entities such as managers 136 and orderers 132, among others. It should be noted that such a transaction proposal 106 could ultimately require involvement (i.e. endorsement) from entities 116 beyond the first organization 116a and second entity 116b, as will be discussed below. In some cases, the first and second entities may both be recommenders 118 (e.g. researcher from a certain university makes known particular data and researchers from other universities are vying to recommend the particular data that was made known, etc.). In other cases, the first and second entities may both be providers 120 (e.g. two different individuals who each elect to provide fitness data from a mobile app they both use, or a corporation providing data in a particular field and a university providing corollary data, etc.). In still other cases, the first entity 116a may be a provider 120, and the second entity 116b may be a recommender 118. While in other cases, a third entity 116c may be an acquirer. The non-limiting example shown in FIG. 2 will be discussed in the context of a transaction proposal 106 received at a first peer 108a belonging to a first entity 116a that is a provider 120, seeking a determination from a second entity 116b that is a recommender 120. However, it should be noted that may other permutations of organizations, as well as query types and sources, are possible.

In some embodiments, the client device 102 may prompt an individual for additional information if the client device 102 may be aware of the particulars for a smart contract 130 that will be executed in response to this type of transaction proposal 106. As a specific example, a provider, such as an individual, may be willing to share data from their fitness tracker to further medical research, but not to refine a marketing campaign within their city. As such a smart contract may be tailored to enforce and execute the parameters of the provider's willingness, especially when proposals concerning the provider's data are made by other entities, such as recommenders and/or acquirers. In other embodiments, the transaction proposal 106 may be submitted from the client device 102 with minimal information, and if some requisite information may be missing, the client device 102 may be notified of the deficiency, or the missing information may be pulled from another source within the first entity 116a.

As shown, once the transaction proposal 106 has been formed by the client device 102, such as a client 102 associated with a recommender, it may be sent to a first peer 108a of the first entity 116a, such as a provider 120. In such a case, the transaction proposal may include a recommendation data object 144, wherein the recommendation data object 144 comprises a recommendation from the recommender that data associated with the data object is valid. A recommendation data object 144 may reference one or more publications discussing data associated with a data object. Moreover, a recommendation data object 144 may comprise a recommendation from the recommender that the data associated with a data object may be relied upon when performing particular operations using the data associated with the data object. In some embodiments, the first peer 108a may also be an endorsing peer 110, meaning it is able to sign the transaction proposal 106 on behalf of the first entity 116a.

A recommendation data object 144 may be recorded as part of the immutable ledger and may also be made available for access in the world state. A recommendation data object 144 pertains to a recommendation or form of verification that one entity (a recommender) may attach to the data offering of another, whereby the recommending entity, in a sense, may stake their reputation on the quality of the data offering. In some embodiments, the entity staking their reputation may receive some sort of benefit for the efforts and risk in providing their verification stake and recommendation. Such a benefit may be to receive a portion of any proceeds generated by the data offering. As a specific example, a researcher may indicate that a particular data set being offered by another entity is of high quality and clean formatting. As a consequence of their endorsement and recommendation of the data set, a small fraction of any subsequent sales of the data offering, as facilitated by the data exchange marketplace system, may go to that researcher. In other embodiments, other incentives may be used in exchange for risking one's reputation, such as a credited allotment of points corresponding to an internal point system shared by entities of the blockchain network, or preferred or expedited access to resources associated with the data exchange marketplace system.

Upon receipt of such a first transaction proposal 106 from a recommender, the first peer 108a (e.g. an endorsing peer 110) identifies a smart contract 130 associated with the query 202 specified in the proposal 106. See circle 2. In the context of the present description, a smart contract 130 comprises is a series of logic operations or steps that represent a procedure being executed on behalf of an entity 116. Smart contracts 130 identify what information is needed, where it needs to come from, what entity 116 need to sign or otherwise endorse or certify a proposal and/or how many peers 108 need to or otherwise endorse, the criteria for rendering a decision, and any other evaluation or function that may be involved in automating a particular procedure, evaluation, or transaction. In some embodiments, nothing is added to the ledger 124 without going through a smart contract 130 first.

In some embodiments, the appropriate smart contract 130 may be identified by matching the missing data in the transaction proposal 106 with an entity 116b in some way linked to the marketing data object 200. According to various embodiments, smart contracts 130 may be implemented as scripts, using languages such as Go or JavaScript, or the like. In some embodiments, smart contracts 130 may be defined along with a policy, or a defined set of requirements that can be passed along to other peers and organizations, such that they are aware of the required information 212, but are not privy to the logic being employed to render a result.

Smart contracts 130 are defined by their entities 116. For example, the smart contract 130 for a provider 120 to allow a recommender 118 to recommend data made known by the provider 120 would be defined, at least in part, by the provider 120, and would include all the steps they would take to make such a determination, including what information is needed, and how it should be validated. Peers 108 may also store copies of the smart contracts 130 of other entities 116, or derivatives of those smart contracts 130, to know what information to pass along. For example, an organization such as the United States Food and Drug Administration (USDA) may have the smart contracts 130 for many different research organizations having data 116 pertinent to the USDA.

According to various embodiments, a smart contract 130 may comprise a chaincode 206 that has been defined by the parent entity 116 (in FIG. 2, the second entity 116b) to automatically adjudicate the query 202 of the transaction proposal 106. The smart contract 130 also comprises an endorsement policy 204. In the context of the present description and the claims that follow, an endorsement policy 204 of a smart contract 130 indicates which entities 116 need to “sign off” on the smart contract 130 before the proposed transaction 106 can be validated and the world state 126 of the ledger 124 updated. The endorsement policy 204 may indicate which entities 116 need to sign, and may also indicate the number of signatures needed (e.g. the number of peers that need to apply their certificates, etc.). In some embodiments, the endorsement policy 204 of a smart contract 130 indicates all of the entities responsible for information 212 required to execute the chaincode 206. For example, in one embodiment, the endorsement policy 204 may indicate, at the least, the parent entity (in FIG. 2, the second entity 116b) and at least one other entity 116, such as the first entity 116a, since the organization that received the transaction proposal 106 must endorse it before it may be submitted to a smart contract 130 and propagated to other entities 116 in the PBN 104.

In some embodiments, the smart contract 130 may also specify an update policy 208, which defines an age threshold for when information will be accepted from the world state 126 and when updated information will be sought from an entity 116. The use of an update policy 208 will be discussed in greater detail, below.

Continuing with the non-limiting prior authorization example shown in FIG. 2, the endorsing peer 110 of the provider 120 (i.e. first entity 116a) may have a copy of the smart contract 130 requirements for recommendation by a recommender 118 (i.e. second entity 116b), which might indicate that asset data corresponding with the marketing data object 200 needs to be identified, along with the existence of a published reference verifying the asset data, the credentialed qualifications of the recommender 116b, and the like.

Once the smart contract 130 associated with the query 202 has been identified, it is invoked in at least one endorsing peer 110 using the transaction proposal 106. See circle 3. According to various embodiments, the smart contract 130 is invoked on endorsing peers 110 belonging to the entities 116 indicated by the endorsement policy 204 of the smart contract 130 (e.g. the list of entities 116 responsible for required information 212).

In the context of the present description and the claims that follow, invoking a smart contract 130 means calling the chaincode 206 of the smart contract 130 by sending a transaction proposal 106 to an endorsing peer 110. The endorsing peer 110, in response, executes the chaincode 206, endorses a proposal response, and returns the endorsed first transaction proposal response. For example, a first transaction proposal may be received on the private blockchain network, from a peer associated with a recommender approved on the private blockchain network, wherein the first transaction proposal comprises a recommendation data object 144. The chaincode 206 may be invoked to execute an applicable smart contract 130 and facilitate the reception of an endorsed first transaction response from the peer associated with recommender.

In some embodiments, invoking a smart contract 130 on one endorsing peer 110 may trigger the invocation of another smart contract 130 in order to respond to the first. For example, as shown in FIG. 2, invoking a first smart contract 130a on a first endorsing peer 110a may comprise executing a second smart contract 130b installed on the first endorsing peer 110a to generate a proposed transaction response 210 to the invocation of the first smart contract 130a. See circle 3.1.

The chain execution of smart contracts 130 is advantageous by giving each entity more control over how the entity interacts or serves a role in the data exchange marketplace. For example, provider may have defined a smart contract 130 for when, in response to a proposed recommendation by a recommender, an alternative recommendation from a second recommender is preferred by the provider, and the provider is seeking agreement from all interested providers (e.g. the first proposed recommender, the second recommender, and potential acquirers, etc.). In other words, the provider has defined a first smart contract 130a that is seeking endorsement from two recommender entities, and possibly an acquirer entity. When the second recommender receives the proposed transaction that the provider sent to its own endorsing peer 110 to trigger execution of the first smart contract 130a, it invokes a second smart contract 130b, defined by provider to determine if a proposed recommendation has any adverse or contrary recommendation with other associated data sets the provider is aware of, or if the second recommender is appropriately credentialed with regard to the asset data the provider maintains. The chain execution of smart contracts allows the second recommender and the provider to define how they carry out their roles within the data exchange marketplace, and the smart contracts work together to allow the process to move forward at a speed and consistency otherwise not possible with conventional data exchange marketplace systems and methods.

In some embodiments, one of the at least one endorsing peers 110 receiving the transaction proposal 106 may be certified by (e.g. issued a cryptographic certificate by, associated with, etc.) the first entity 116a (i.e. it is sent to the entity associated with the client device 102 that originally provided the transaction proposal 106). This is advantageous, as it reduces the amount of information a client device 102 is required to have access to in order to invoke the smart contract 130. For example, allowing the smart contract to request additional information from the first entity means that the client device 102 only need supply enough information that the endorsing peer 110 is able to identify the appropriate smart contract to invoke, and what that smart contract is looking into (e.g. credibility of recommender, viability of acquirer, what a data object is intended to be used for once acquired, etc.). The first entity can then be queried to obtain any additional information that the first entity 116a is responsible for and that the second entity 116b needs to fully execute the chaincode 206 of the smart contract 130. Once a peer associated with the second entity, such as a provider, fully executes the chaincode 206, an endorsed first transaction proposal response may be received. A fully executed smart contract may provoke the addition of the transaction proposal, such as a recommendation data object 144, to the marketing data in the world state.

In some embodiments, a peer 108 may seek for information within systems that exist outside of the private blockchain network 104. While peers 108 within the PBN 104 can be forced to communicate using a data format 220 that has been agreed upon by the entities that make up the PBN 104, the same cannot be said for systems outside of the PBN 104. Accordingly, in some embodiments, entities 116 may have one or more data aggregators 112 that may be used to interact with systems external to the PBN 104.

For example, in some embodiments, the DEM system 100 may transact with legacy systems 218, such as, for example, systems associated with university databases, corporate data repositories, court and law firm docketing systems, and/or cloud-based data storage and exchange systems, and the like, allowing an entity to provide unfettered access to their representative entity 116 within the PBN 104 without requiring the abandonment of systems, such as legacy system 218, that may have been built up over a long period of time and at great expense. As shown in FIG. 2, the invocation of a smart contract 130 on an endorsing peer 110 may result in that peer requesting a data object 214 from a legacy system 218 through a data aggregator 112. The data object 214 may be provided by the legacy system 218 in a legacy format 222. The data aggregator 112 may receive that data object 214 in a legacy format 222, and transform it into a format 220 compatible with the PBN 104, according to various embodiments. See circle 3.2. According to various embodiments, the data aggregator 112 may be used to format and send a data object 214 from the DEM system 100 to a legacy system 218, or otherwise interact with the legacy system 218.

As a more specific example of how this may be used, a set of census data having details about racial and economic strata pertaining to residents of a certain area may be stored on an internal census bureau database that the peer queries through the data aggregator, obtaining access to asset census data ultimately needed for an acquirer, such as a corresponding governing body to render a decision regarding whether the asset data may be formatted for use in contriving boundaries for voting districts corresponding to the certain area for which the census data pertains.

In some embodiments, the peer 108 may seek information outside of the DEM system 100 by interacting with a third-party via a data aggregator 112, as shown in circle 3.3. In some instances, required information 212 may be held on a third-party server 216. Examples include, but are not limited to, servers belonging to regulatory or oversight entities, trade groups, non-governmental organizations, consumer groups, libraries of various sorts, and other entities that are not represented by organizations within the PBN 104. These servers 216 may hold required information that does not exist on the blockchain network 104. As shown in FIG. 2, the invocation of a smart contract 130 on an endorsing peer 110 may result in that peer requesting a data object 214 from a third-party server 216 through a data aggregator 112. The data object 214 may be provided by the third-party server 216 in a third-party format 224. The data aggregator 112 may receive that data object 214 in the third-party format 224, and transform it into a format 220 compatible with the PBN 104, according to various embodiments. According to various embodiments, the data aggregator 112 may be used to format and send a data object 214 from the DEM system 100 to a third-party server 216.

As mentioned previously, the immutable ledger 124 comprises a world state 126 from which the last known values for various “facts” known to the DEM system 100 may be accessed. In some embodiments, that access may resemble retrieving information from a conventional database. The use of a world state 126 can enhance the performance of the DEM system 100, allowing chaincode to act automatically, autonomously, and/or immediately without having to request every piece of required information 212 be pulled from the source entities upon every execution. In other words, the required information 212 provided in an endorsed proposed transaction response can come from either reading the world state 126, or updating the world state 126. The responsible entity updates the world state 126 as a consequence of executing a smart contract that obtains the latest known value for that information from a source other than the ledger 124 (e.g. pulling it from a legacy system 218 using a data aggregator 112, etc.).

In some embodiments, the decision of whether to obtain required information 212 from the ledger 124 or requesting fresh data from the responsible organization may be determined by an update policy 208 specified within the smart contract 130. According to various embodiments, an update policy 208 may provide a threshold age. If the value for the required information 212 found in the world state 126 is younger (i.e. it was placed on or updated on the ledger 124 sooner than the threshold age) than the threshold age, the information from the world state 126 may be used. Otherwise, the information is requested via a smart contract 130 defined to cause the world state 126 to be updated by the responsible organization 116. The use of an update policy 208 may allow a smart contract 130 to enjoy the performance benefits of the world state 126 for information that is fresh, or that does not change (e.g. an individual's birthdate, etc.) while also making sure that required information 212 that is prone to change, such as the cost to acquire a data asset, is up-to-date.

In some cases, sensitive and/or private information may need to be shared, but should not be stored on the broadly available immutable ledger 124. In such instances, the transaction may be completed in one of two ways: using channels, to be discussed with respect to FIG. 3, and/or through a peer-to-peer transfer, to be discussed with respect to FIG. 4.

Once the endorsing peer 110 has determined that it has fulfilled its portion of the smart contract 130, it endorses a proposed transaction response 210 containing the required information 212 that entity is responsible for. The endorsed proposed transaction response may be an endorsed first transaction proposal response that responds to a first transaction proposal. According to various embodiments, the endorsed proposed transaction response 210 is sent to the orderer, or ordering entity 132. See circle 4. The orderer 132 is a special type of entity that may be tasked with the responsibility of ordering and defining the ledger 124. It may comprise one or more ordering peers 134 and one or more databases 122 to store ledgers 124 for all of the PBNs 104 to which it belongs.

According to various embodiments, the orderer 132 disseminates the transaction proposal to invoke a smart contract 130 in all of the entities indicated in the endorsement policy, for example if both the peer associated with the provider and the peer associated with the recommender must execute corresponding smart contracts, to then each provide an endorsed transaction proposal response. The ordering peer 134 determines what, if anything, else is needed to fulfill a smart contract invocation. According to various embodiments, the orderer 132 is only concerned with the signatures, whether the proper number of signatures have been obtained, and/or whether the proper peers have signed. The actual chaincode 206 of the smart contract 130 is inconsequential to the activity of the ordering peer 134, and may be entirely opaque.

Upon determination that additional signatures are needed, the ordering peer 134 sends out signature requests to peers of the appropriate entities. Continuing with the above example, the ordering peer 134 may see that the provider 120 has signed, but the signatures of the recommender (which may provide the recommendation) is also needed, so the transaction proposal 106 is sent to peers 108 for both entities 116. The information from the provider, such as a university research lab, may be obtained by the recommender to evaluate the overall veracity of the asset data by requiring two signatures from the recommender, the second coming back with the provider response, or may wait at the recommender until the proper information is available. In another embodiment, the smart contract 130 may be written such that only the recommender knows who else is being queried; once the signed proposal 106 comes from the provider 120, the recommender 118 may then execute other smart contracts to obtain additional information (i.e. from the provider, or from a potential acquirer, etc.) that the full contract requires for execution. Structuring the contracts in such a way allows for changes to be made internally without changing the way other entities initiate the process. In some embodiments, if additional signatures are needed, the orderer 132 may execute those requests in parallel. In other embodiments, the smart contract 130 may specify that requests be made serially.

Once all of the required information 212 is available, meaning a proposed transaction response 210 has been received from each of the entities specified in the endorsement policy 204, the chaincode 206 may be executed on a second peer 104b (e.g. an endorsing peer 110) at the second entity 116b, automatically adjudicating the query 202 by operating on the required information 212 to assign a value 234 to the determination. See circle 5. The logic embodied within the smart contract 130 allows the DEM system 100 to potentially replace slow and dumb web interfaces and/or call centers of conventional systems with a fast, automated system that is able to provide quick responses through an immutable ledger 124 that all parties can rely on. These smart contracts 130 can manage intra-entity and inter-entity transactions, and can be used to manage a variety of procedures, including but not limited to determining eligibility, granting prior authorization, status monitoring, cost for data acquisition, benefits inured to entities, data compliance, and credentialing. The only limit to what kind of decisions can be automatically made through the chaincode is what the second entity is comfortable turning over to the logic operations defined within the smart contract 130.

In some cases, the chaincode 206 may be defined such that an automatic adjudication may be made for well understood cases of that particular query, while also recognizing that other instances of the required information may be too nuanced to leave up to a machine. According to various embodiments, the value 234 provided at the end of executing the chaincode may include an actual answer (e.g. yes, no, etc.) or may indicate that the query has been escalated for evaluation by a human agent 232 through a client device 102. See circle 6. Having the option of escalation allows entities to turn over a wider range of query types to the smart contracts, recognizing that many times there is an easy answer, without worrying about getting the edge cases wrong. Over time, as the edge cases may become better understood, and the smart contracts may be expanded to cover them without escalation to a human agent.

Once the orderer 132 has determined that the smart contract 130 has been fulfilled (i.e. all the entities indicated by the endorsement policy have endorsed, and the signatures have been validated with the certificate authorities), the orderer 132 puts the transaction in sequence to be added to the ledger 124. See circle 7.1. The ordering peer places the transactions in order, determines if any are still in progress, and adds them to the historical transaction data 128 and the world state 126 (if all required signatures are present). For example, a recommendation data object 144 may be added to the marketing data object accessible in the world state. It should be noted that all transactions, whether valid or invalid, are added to the historical transaction data 128; only valid transactions update the world state 126.

If the orderer 132 fails to get the needed signatures, it may indicate that the request has failed to the first peer 108a, which may then communicate to the client device 102 why the request failed (e.g. missing information, technical difficulty such as a timeout, etc.). A failure, as determined by the orderer 132, is purely a matter of signatures, and does not indicate the actual determination made by the execution of the smart contract 130. For example, a transaction proposal 106 that seems to be a success to the orderer 132, and added to the world state 126, may in fact indicate that the request has been denied, for example, because of lack of proper credentials associated with the recommender. Put another way, the orderer 132 deals with purely administrative matters of the DEM system 100 (e.g. its operation), while the smart contracts 130 handle the substantive matters.

Upon updating the ledger 124 stored at the orderer 132, the ordering peer 134 may send a message to the anchor peer 114 of each entity 116. See circle 7.2. This message may contain the update to the ledger 124 that the peers 108 should add to their database 122. Upon receipt, the anchor peers 114 may disseminate the update to any other peers 108 within their entity 116. See circle 7.3. Ledger synchronization may be performed very quickly; in some embodiments, the synchronization may be performed in real-time or near real-time. The immutable nature of the ledger 124 forces all parties to honor their previous statements.

Finally, the first peer 108a may communicate the results back to the client device 102. See circle 8. This may include a unique identifier for the transaction, and the result of executing the smart contract 130 (i.e. the value 234 of the determination). If it failed to get the proper signatures, the client device 102 may indicate why, and what may be done to be successful in the future (e.g. what information to provide, etc.). Successful requests, meaning the endorsement policy was fulfilled, are added to the immutable blockchain ledger 124, whether they had positive results or not. To reiterate what was said above, just because a peer 108 has endorsed a transaction does not mean it was approved.

The process may be repeated, in parallel or in series, with regard to further interactions between entities. For example, a second transaction proposal may be received on the blockchain network from a peer associated with an acquirer approved on the blockchain network. The second transaction proposal 106 may comprise an acquisition data object 146. The acquisition data object 146 may include information about who the acquirer is or what characteristics define the acquirer entity. For instance, the acquisition data object 146 may identify the acquirer as a marketing department for a large corporation, as a medical research team, or as social network provider, etc. Moreover, the acquisition data object 146 may include information about what the acquirer intends to do with the asset data, once acquired. Such information may be critical to a providing entity who desires that the asset data associated with a data object be used only for medical research purposes, as opposed to generating marketing demographic targets, or other commercial purposes.

Like the process associated with fulfillment of the first transaction proposal, a second transaction proposal may provoke a succession of automated actions taken by appropriate peers corresponding to interacting entities, to execute applicable smart contracts and render determination for action pertaining to the second transaction proposal. Upon execution of the smart contract(s), an endorsed second transaction proposal response may be received from each of, the peer associated with the provider and the peer associated with the acquirer. In a manner similar to that discussed regarding the first transaction proposal and endorsed first transaction proposal response, the endorsed second transaction proposal response may be facilitated by a smart contract executable by at least the peer associated with the provider, wherein the smart contract provides a governing protocol for automatic implementation of a decision-making process determining whether the acquirer meets qualifications permitting possession of the data object. Such qualification may, for example, be associated with a data use policy dictating who may possess the data object based on how the asset data associated with the data object is intended to be used by one who possesses it. A smart contract may evaluate, in a sense, the acquisition data object 146, to determine qualifications of the acquirer and help facilitate effectuation of the endorsed second transaction proposal response by one and/or both applicable interacting entities.

Similar to the processes corresponding to the first transaction, with additional transaction proposals, such as a second transaction proposal from a peer associated with an acquirer, the ordering peer may see that the acquirer has signed, but the signatures of the data provider are also needed, so the transaction proposal may be sent to a peer for the second provider. The information from another entity may be obtained by the provider to evaluate the identity or intention of the acquirer by requiring two signatures from the provider, the second coming back with the validation response, or may wait at the provider until the proper information is available. In another embodiment, the smart contract may be written such that only the data provider knows who else is being queried; once the signed proposal comes from the acquirer, the provider may then execute other smart contracts to obtain additional information (i.e. validating identity of acquirer, verifying cost for acquiring the data object, verifying intended use for asset data 402 once it is acquired, etc.). Once all requisite parties have signed and an endorsed second transaction proposal is received from each of, the peer associated with the provider and the peer associated with the acquirer, the acquisition data object 146 may be added to the marketing data object in the world state.

The execution of the DEM system 100 in a private blockchain network 104 provides opportunities that are not practical to implement in conventional systems. The immutable historical transaction data 128 can provide insights into the structure and function of a data exchange marketplace that were previously obscured by the lack of trust and uniformity that prevented anyone from seeing the big picture. For example, in some embodiments, the historical transaction data may have new applications in training machine learning models, as well as oversight of the data exchange marketplace itself, and all of the players within.

In some embodiments, historical transaction data 128 may be used to train a machine-learning model 226. For example, as shown in FIG. 2, a peer 108 within an entity (here, the manager entity 136) may be communicatively coupled to a database 122 having the ledger 124 as well as to a data science system 138 capable of training a machine learning model 226 using the historical transaction data 128 pulled by the peer 108 from the ledger 124. See circle 9. The data science system 138 could be part of any entity 116. In some embodiments, the historical transaction data 128 may be passed through some sort of cleansing mechanism, such as a specially configured data aggregator 112, which obfuscates sensitive private data to remain in compliance with privacy laws.

In some embodiments, a machine-learning model 226 that is trained with the historical data 128 may be a propensity-to-acquire model, using information including but not limited the number of recommendations pertinent to a data object, the identity of the recommenders recommending and data object and the identity of a provider of a data object, to build a model that can predict the likelihood and possibly the timeline for acquisition of a data object identified through a market data object accessible in a world state associated with the data exchange market place system. Those skilled in the art will recognize that other ML models could be trained using the data stored in the ledger 124, as well.

In some embodiments, the world state 126 and historical transaction data 128 of the ledger 124 may be used for oversight purposes. For example, as shown in FIG. 2, a peer 108 within an entity (here, the manager entity 136) may be communicatively coupled to a database 122 having the ledger 124 as well as to a watchdog system 140 configured to compare the world state 126 with the historical transaction data 128 to identify an unwelcome action 228. See circle 10. Unwelcome actions 228 may include, but are not limited to data falsification, fraudulent acquisition of data, false specification as to intended data usage; corruption of data, breach(es) of confidentiality, waste due to poorly defined smart contracts, and the like. In some embodiments, the watchdog system 140 may employ machine learning to identify the unwelcome actions 228.

Moreover, in some embodiments, implementations of a data exchange marketplace system may serve as a marketplace or free exchange of data sets, with the transactions being limited to sharing of data different entities are providing. In other embodiments, a data exchange marketplace system may facilitate data operations and improvements. For example, in one embodiment, an entity may obtain data from a plurality of individuals that fit particular criteria in association with a data object, though the marketplace. After aggregating the obtained asset data into a nicely formatted set, the entire package may then be placed on the marketplace for other entities, such as researchers, to obtain. As another example, one entity may be offering a robust, yet messy, dataset. Another entity may propose that they clean up the data set, in exchange for a portion of resulting proceeds, or for a flat fee. In still another embodiment, one entity may provide a data set on the marketplace, which is purchased by another entity that then builds a machine-learning model based upon the data. That ML model may subsequently be listed alongside the data object associated with the data set, and may be packaged together with the two entities sharing the proceeds. A data exchange marketplace system, by facilitating cooperation between parties by, inter alia, removing the need for all-inclusive trust through the blockchain implementation, enables the improvement of the asset data being offered with a very low barrier to entry, unlike conventional marketplaces and data exchanges. In addition, manifestation of the occurrence of an operation performed upon data associated with a data object may correspond with the placement, in sequence, of the existence of the operation onto the immutable transaction history of the blockchain network.

FIG. 3 is a schematic view of a non-limiting example of a DEM system 100 making use of multiple channels 300. Privacy and protection of data is, or may be, of great importance within all or parts of a data exchange marketplace system. The advantages that come from the use of an immutable ledger 124 must be balanced with the risks of exposing certain data to the wrong entities 116. Various embodiments of the DEM system 100 allow for the abstraction of world state 126 and historical transaction data 128 into channels 300, effectively partitioning or compartmentalizing the information.

FIG. 3 shows a non-limiting example of an DEM system 100 made up of six entities 116a-f interacting through three different channels 300, main (channel 300a), [b,f] (channel 300b), and [c,e] (channel 300c). Each entity 116, or more specifically the peer databases 122 of each entity 116, will maintain a world state 126 and a historical transaction data 128 for each channel 300 in which the entity 116 is participating. As shown, entity 116e, being part of the main channel 300a as well as the [c,e] channel 300c, would have two sets of ledgers 124, one for ‘main’ and one for ‘[c,e]’. Entity 116f is not part of the main channel 300a, but does participate in a channel 300b with entity 116b, so it only has a ledger 124 for channel 300b ‘[b,f]’. The main channel 300a, shared across many entities, may have less sensitive information, while the smaller channels, such as channel 300c [c,e], may have private data that is critical to the operations of entities 116c and 116e, but is both sensitive and not mission critical to the other entities 116.

According to various embodiments, channels 300 may be established between entities 116 that have long standing relationships, and that interact often. They may be used to communicate sensitive information. In some embodiments, some information that is particularly sensitive may be ephemeral. For example, an entry in the ledger 124 may be flagged such that it references information that will expire after a certain number of block updates, making it no longer accessible outside the originating entity 116. Ephemeral data such as this may still be trusted through the inclusion of a hash of the data alongside ledger entries for transactions based upon the data. Any later disputes may be settled by rehashing the original data, held on to the by the originating organization.

It should be noted that these “smaller” channels 300 shown in FIG. 3 are not necessarily subsets of main channel 300a. In fact, they may have a great deal more information than the main channel 300a. For example, a channel may comprise a collection of entities that are all affiliated with an organization, such as a university (e.g. the entities may be individual researchers or departments). These entities may participate in a data exchange marketplace system for the sharing and/or purchasing of data, but also freely share information with each other through their own channel, as part of an internal data exchange. Such an arrangement may both facilitate sharing of data within an organization such as a university, as well as enable the monetization of their data sets and models.

Channels 300 may be advantageous for compartmentalization of sensitive data between relevant entities 116, but they may require a non-negligible amount of overhead to maintain (e.g. separate ledgers 124, parallel networks 104, etc.). The overhead may be a small price to pay when providing a secure conduit between entities 116 with an ongoing and active relationship, but there may also arise situations where such a relationship does not exist, and does not warrant the creation of a channel 300 for a single or intermittent transactions.

After an acquisition data object 146 is added to a world state, the data object may be shared by a provider. In some embodiments, data assets may be exchanged by making a copy of the data object accessible in a world state and allowing entities, such as an acquirer to, thereby, access the asset data. When an acquirer accesses a copy of the data object via the world state, the acquirer may validate that the copy of the data object has a second hash that identically matches the first hash of the data object contained in the marketing data object of the world state. According to various other embodiments, the DEM system 100 may also allow for private peer-to-peer direct communication that bypasses the blockchain network 104 altogether, while still allowing for data and transactions to be verified using the immutable shared ledger 124. FIG. 4 is a schematic view of a non-limiting example of peers 108 from two entities 116 engaging in a peer-to-peer communication.

In this example, the first entity 116a, such as a provider, for example, a company offering mobile applications for women's health issues, needs to provide asset data 402, such as a gathered cache of data associated with a fertility tracking mobile application including information on the average number of times per week a group of individuals using the fertility application engages in heterosexual intercourse, to a third entity 116c, such as a potential acquirer, for instance, a university research department focused on obstetric and gynecological studies. However, the information pertaining to the asset data 402 should not be exposed on the general blockchain ledger 124 associated with a data exchange marketplace system of which the provider and the acquirer are both entities 116, and a channel 300 does not exist between these two entities 116. As shown, the asset data 402 may be directly transmitted from the first entity 116a to the third entity 116c through a temporary connection, without being added to the ledger 124. However, the transaction is not left off of the ledger 124 completely. Before transmitting, the first entity 116a performs a hash 400 of the asset data 402, using any hashing technology or methods known in the art. The hash 400 is added to the marketing data object and may be added to a transaction proposal 106 signed by the first entity 116a and sent to the third entity 116c through the orderer 132. The orderer 132 may request a signature from the third entity 116c indicating that their hash 400 of the data matches the hash provided by the first entity 116a and existent in the descriptive data 234 pertinent to the marketing data object of the world state. The signature of the third entity 116c may fulfill the smart contract 130, and may be added to the blockchain ledger 124, along with the hash 400. The sensitive data cannot be extracted from the hash 400 by the other entities 116 associated with the data exchange marketplace system, but if, at a later date, a dispute arises as to what the asset data 402 said, a rehashing of the data will further facilitate validation, because either match the hash 400 found on the ledger 124 will indicate it is the same as was originally transmitted peer-to-peer, or it will not match, thereby indicating it has been modified since the transmission. As an option, data shared via peer-to-peer may also be ephemeral, as previously discussed.

Embodiments of a data exchange marketplace system may comprise interactive data exchange potentially bolstered by the introduction of credits or incentives and facilitated benefits for data providers (for providing access to data), for data recommenders (for recommending the operable viability and genuine veracity of known data sets), and/or for acquirers (for their acquisition of available data and possible operation thereupon). Other entities, such as managers, watchdogs and orderers, may also receive credit in conjunction with their participatory action in a data exchange marketplace system. Credit attributed to an entity may be associated with a corresponding credit data object 148 associated with the entity. For example, a credit data object 148 may be associated with an entity that functions as a provider, an entity that functions as a recommender, and/or an entity that functions as an acquirer.

Applicant has noted that an interactive data exchange may be bolstered by introducing credits or incentives and facilitating benefits for data providers (for providing access to data), for data recommenders (for recommending the operable viability and genuine veracity of known data sets), and/or for acquirers (for their acquisition of available data and possible operation thereupon). While traditional marketplaces and other exchange systems fail to offer effective credits, incentives and/or benefits the interactive data exchange disclosed herein may advantageously provide such credit or incentives.

A credit data object 148 may be listed on an immutable transaction history of a blockchain network associated with a data exchange marketplace system. Moreover, a credit data object 148 may include information pertaining to a tally of points associated with an internal point system of the blockchain network, wherein the internal point system corresponds to transactions effectuated by entities associated with the blockchain network. In addition, a credit data object 148 may pertain to a benefit inured to an entity. For example, a credit data object 148 may pertain to a benefit inured to a provider, to a benefit inured to a recommender, and/or to a benefit inured to an acquirer. The benefit may be an allotment of points associated with the internal point system of the blockchain network. Furthermore, the benefit may comprise remuneration to the provider, following at least the addition of descriptive data 234 to the marketing data object in the world state. For instance, an individual may receive remuneration for providing asset data, such as six months of fitness data compiled by the fitness app on their smart watch, wherein the fitness data may be described in a corresponding marketing data object in the world state, so that other entities may become aware of the provided fitness data. The remuneration may be a monetary compensation for action taken by the individual to provide their fitness data. Similarly, the benefit may be remuneration to the recommender, following at least the adding of a recommendation data object 144 to the marketing data object in the world state, like where a university athletic program recommends data from the fitness app, such as the fitness data provided by the individual, because the athletic program can vouch for the accuracy of similar fitness data generated by their athletes and compiled by the fitness application, and the recommendation is described in a recommendation data object 144 added to the marketing data object accessible by all entities of the blockchain network. A benefit may be apportioned between at least two of a provider entity, a recommender entity and/or an acquirer entity.

Additionally, a credit data object 148 may pertain to a benefit comprising an allocation of preferred access to resources associated with the blockchain ledger. For instance, a corporation who consistently acquires data associated with a data exchange marketplace system may obtain a trusted entity status, whereby the corporation may become privy to data not otherwise available to other entities. A credit data object 148 may be associated with the corporation. In an instance where the corporation functions as an acquirer of a data object via a data exchange marketplace system, the corporation's corresponding credit data object 148 may be modified after the associated acquisition data object 146 is added to the world, after the corporation possesses a copy of the data object, and after the corporation verifies that a second hash of the copy of the data object identically matches the first hash of the data object contained in the marketing data object of the world state. The acquiring corporation's efforts may therefore be reward by their credit data object 148 being modified to indicate a credit allotted to the corporation. The modification of a credit object of an entity, such as the acquiring corporation, may be listed the immutable transaction history of the blockchain network as having occurred. In this manner, other entities may determine and verify that the acquiring corporation received a credit for its actions.

FIG. 5 is a schematic view of a non-limiting example of multiple blockchain networks 104, each representing an implementation of a DEM system 100, being bridged by a Manager entity 136. In some cases, information sharing will be advantageous between entire networks, rather than limited to a peer-to-peer basis. FIG. 5 shows how a manager entity 136, using a data aggregator 112 as previously discussed, may be used to bridge different blockchain networks 104a-c that may be using different common formats or other shared conventions. As shown, the manager 136 may have peers 108a-c operating simultaneously on multiple networks, or networks using different architectures or built upon different blockchain frameworks.

FIG. 6 is a schematic diagram of specific computing device 600 and a specific mobile computing device 650 that can be used to perform and/or implement any of the embodiments disclosed herein. In one or more embodiments, the shared computing environment on which the system may be hosted in a virtualized or containerized implementation may be the specific computing device 600, or a collection of the specific computing device 600 operating together in a distributed manner, as is known in the art. In other embodiments, the specific computing device 600 may represent one or more of the following: client device 102, a peer 108, a data aggregator 112, a database 112, a data science system 138, a watchdog system 140, a third-party server 216, a legacy system 218, and/or a human agent interface system 230. The specific mobile computing device 650 may also be a client device 102, according to various embodiments.

The specific computing device 600 may represent various forms of digital computers, such as laptops, desktops, workstations, personal digital assistants, servers, blade servers, mainframes, and/or other appropriate computers. The specific mobile computing device 630 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed, according to one embodiment.

The specific computing device 600 may include a processor 603, a memory 605, a storage device 606, a high-speed interface 608 coupled to the memory 605 and a plurality of high-speed expansion ports 610, and a low-speed interface 612 coupled to a low-speed bus 614 and a storage device 606. In one embodiment, each of the components heretofore may be inter-coupled using various buses, and may be mounted on a common motherboard and/or in other manners as appropriate. The processor 603 may process instructions for execution in the specific computing device 600, including instructions stored in the memory 605 and/or on the storage device 606 to display a graphical information for a GUI on an external input/output device, such as a display unit 616 coupled to the high-speed interface 608, according to one embodiment.

In other embodiments, multiple processors and/or multiple buses may be used, as appropriate, along with multiple memories and/or types of memory. Also, a plurality of specific computing device 600 may be coupled with, with each device providing portions of the necessary operations (e.g., as a server bank, a group of blade servers, and/or a multi-processor system).

The memory 605 may be coupled to the specific computing device 600. In one embodiment, the memory 605 may be a volatile memory. In another embodiment, the memory 605 may be a non-volatile memory. The memory 605 may also be another form of computer-readable medium, such as a magnetic and/or an optical disk. The storage device 606 may be capable of providing mass storage for the specific computing device 600. In one embodiment, the storage device 606 may be includes a floppy disk device, a hard disk device, an optical disk device, a tape device, a flash memory and/or other similar solid-state memory device. In another embodiment, the storage device 606 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described above. The instructions may be stored in the memory 605, the storage device 606, a memory coupled to the processor 603, and/or a propagated signal.

The high-speed interface 608 may manage bandwidth-intensive operations for the specific computing device 600, while the low-speed interface 612 may manage lower bandwidth-intensive operations. Such allocation of functions is exemplary only. In one embodiment, the high-speed interface 608 may be coupled to the memory 605, the display unit 616 (e.g., through a graphics processor and/or an accelerator), and to the plurality of high-speed expansion ports 610, which may accept various expansion cards.

In the embodiment, the low-speed interface 612 may be coupled to the storage device 606 and the low-speed bus 614. The low-speed bus 614 may be comprised of a wired and/or wireless communication port (e.g., a Universal Serial Bus (“USB”), a Bluetooth® port, an Ethernet port, and/or a wireless Ethernet port). The low-speed bus 614 may also be coupled to the scan unit 628, a printer 626, a keyboard, a mouse 624, and a networking device (e.g., a switch and/or a router) through a network adapter.

The specific computing device 600 may be implemented in a number of different forms, as shown in the figure. In one embodiment, the specific computing device 600 may be implemented as a standard server 618 and/or a group of such servers. In another embodiment, the specific computing device 600 may be implemented as part of a rack server system 622. In yet another embodiment, the specific computing device 600 may be implemented as a general computer 620 such as a laptop or desktop computer. Alternatively, a component from the specific computing device 600 may be combined with another component in a specific mobile computing device 630. In one or more embodiments, an entire system may be made up of a plurality of specific computing device 600 and/or a plurality of specific computing device 600 coupled to a plurality of specific mobile computing device 630.

In one embodiment, the specific mobile computing device 630 may include a mobile compatible processor 632, a mobile compatible memory 634, and an input/output device such as a mobile display 646, a communication interface 652, and a transceiver 638, among other components. The specific mobile computing device 630 may also be provided with a storage device, such as a microdrive or other device, to provide additional storage. In one embodiment, the components indicated heretofore are inter-coupled using various buses, and several of the components may be mounted on a common motherboard.

The mobile compatible processor 632 may execute instructions in the specific mobile computing device 630, including instructions stored in the mobile compatible memory 634. The mobile compatible processor 632 may be implemented as a chipset of chips that include separate and multiple analog and digital processors. The mobile compatible processor 632 may provide, for example, for coordination of the other components of the specific mobile computing device 630, such as control of user interfaces, applications run by the specific mobile computing device 630, and wireless communication by the specific mobile computing device 630.

The mobile compatible processor 632 may communicate with a user through the control interface 636 and the display interface 644 coupled to a mobile display 646. In one embodiment, the mobile display 646 may be a Thin-Film-Transistor Liquid Crystal Display (“TFT LCD”), an Organic Light Emitting Diode (“OLED”) display, and another appropriate display technology. The display interface 644 may comprise appropriate circuitry for driving the mobile display 646 to present graphical and other information to a user. The control interface 636 may receive commands from a user and convert them for submission to the mobile compatible processor 632.

In addition, an external interface 642 may be provide in communication with the mobile compatible processor 632, so as to enable near area communication of the specific mobile computing device 630 with other devices. External interface 642 may provide, for example, for wired communication in some embodiments, or for wireless communication in other embodiments, and multiple interfaces may also be used.

The mobile compatible memory 634 may be coupled to the specific mobile computing device 630. The mobile compatible memory 634 may be implemented as a volatile memory and a non-volatile memory. The expansion memory 658 may also be coupled to the specific mobile computing device 630 through the expansion interface 656, which may comprise, for example, a Single In-Line Memory Module (“SIMM”) card interface. The expansion memory 658 may provide extra storage space for the specific mobile computing device 630, or may also store an application or other information for the specific mobile computing device 630.

Specifically, the expansion memory 658 may comprise instructions to carry out the processes described above. The expansion memory 658 may also comprise secure information. For example, the expansion memory 658 may be provided as a security module for the specific mobile computing device 630, and may be programmed with instructions that permit secure use of the specific mobile computing device 630. In addition, a secure application may be provided on the SIMM card, along with additional information, such as placing identifying information on the SIMM card in a non-hackable manner.

The mobile compatible memory may include a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on the mobile compatible memory 634, the expansion memory 658, a memory coupled to the mobile compatible processor 632, and a propagated signal that may be received, for example, over the transceiver 638 and/or the external interface 642.

The specific mobile computing device 630 may communicate wirelessly through the communication interface 652, which may be comprised of a digital signal processing circuitry. The communication interface 652 may provide for communications using various modes and/or protocols, such as, a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol.

Such communication may occur, for example, through the transceiver 638 (e.g., radio-frequency transceiver). In addition, short-range communication may occur, such as using a Bluetooth®, Wi-Fi, and/or other such transceiver. In addition, a GPS (“Global Positioning System”) receiver module 654 may provide additional navigation-related and location-related wireless data to the specific mobile computing device 630, which may be used as appropriate by a software application running on the specific mobile computing device 630.

The specific mobile computing device 630 may also communicate audibly using an audio codec 640, which may receive spoken information from a user and convert it to usable digital information. The audio codec 640 may likewise generate audible sound for a user, such as through a speaker (e.g., in a handset smartphone of the specific mobile computing device 630). Such a sound may comprise a sound from a voice telephone call, a recorded sound (e.g., a voice message, a music files, etc.) and may also include a sound generated by an application operating on the specific mobile computing device 630.

The specific mobile computing device 630 may be implemented in a number of different forms, as shown in the figure. In one embodiment, the specific mobile computing device 630 may be implemented as a smartphone 648. In another embodiment, the specific mobile computing device 630 may be implemented as a personal digital assistant (“PDA”). In yet another embodiment, the specific mobile computing device, 630 may be implemented as a tablet device 650.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including one programmable processor, which may be special or general purpose, coupled to receive data and instructions from, and to transmit data and instructions to, a storage system, one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal (“LCD”) monitor) for displaying information to the user and a keyboard and a mouse by which the user can provide input to the computer. Other kinds of devices can be used to provide for interaction with a user as well; for example, feedback provided to the user can be any form of sensory feedback (e.g., visual feedback, auditory feedback, and/or tactile feedback) and input from the user can be received in any form, including acoustic, speech, and/or tactile input.

The systems and techniques described here may be implemented in a computing system that includes a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In one embodiment, the client and the server are remote from each other and interact through the communication network.

A number of embodiments have been described. Nevertheless, it will be understood that various modifications may be made without departing from the spirit and scope of the present disclosure. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the claims following the description set forth herein.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

Where the above examples, embodiments and implementations reference examples, it should be understood by those of ordinary skill in the art that other networks, protocols, and hardware and examples could be intermixed or substituted with those provided. In places where the description above refers to particular embodiments of systems and methods for providing a data exchange marketplace through a blockchain network, it should be readily apparent that a number of modifications may be made without departing from the spirit thereof and that these embodiments and implementations may be applied to other to data exchange marketplaces and industries as well. Accordingly, the disclosed subject matter is intended to embrace all such alterations, modifications and variations that fall within the spirit and scope of the disclosure and the knowledge of one of ordinary skill in the art.

What is claimed is:

1. A method for providing a data exchange marketplace through a private blockchain network, the method comprising:
creating a marketing data object in a world state associated with the blockchain network, wherein the marketing data object provides open access on the private blockchain network to details about a data object stored on a database;
adding descriptive data to the marketing data object, the descriptive data received from a peer associated with a provider, the descriptive data comprising a first hash of the data object;
receiving a first transaction proposal on the private blockchain network, from a peer associated with a recommender approved on the private blockchain network, the first transaction proposal comprising a recommendation data object;
receiving an endorsed first transaction proposal response from each of, the peer associated with the provider and the peer associated with the recommender;
adding the recommendation data object to the marketing data object in the world state;
receiving a second transaction proposal on the private blockchain network, from a peer associated with an acquirer approved on the private blockchain network, the second transaction proposal comprising an acquisition data object;
receiving an endorsed second transaction proposal response from each of, the peer associated with the provider and the peer associated with the acquirer;
adding the acquisition data object to the marketing data object in the world state;
facilitating possession of a copy of the data object for the acquirer, wherein possession is only facilitated after the acquisition data object is added to the world state;
facilitating validation, by the acquirer, that the copy of the data object has a second hash that identically matches the first hash of the data object contained in the marketing data object of the world state; and
modifying at least one of a credit data object associated with the provider, a credit data object associated with the recommender, and a credit data object associated with the acquirer.

2. The method of claim 1, wherein the recommendation data object comprises a recommendation from the recommender that the data associated with the data object is valid.

3. The method of claim 1, wherein the acquisition data object includes information about who the acquirer is and what the acquirer plans to do with the data, once the data is possessed by the acquirer.

4. The method of claim 1, wherein the database storing the data object resides outside of the blockchain network.

5. The method of claim 1, wherein the endorsed second transaction proposal response is facilitated by a smart contract executable by at least the peer associated with the provider, wherein the smart contract provides a governing protocol for automatic implementation of a decision-making process determining whether the acquirer meets qualifications permitting possession of the data object.

6. The method of claim 5, wherein the qualifications are associated with a data use policy dictating who may possess the data object based on how the data associated with the data object is intended to be used by the one who possesses the data object.

7. The method of claim 5, wherein the smart contract evaluates the acquisition data object to determine qualifications of the acquirer and facilitate effectuation of the endorsed second transaction proposal response.

8. The method of claim 1, wherein the modification of the at least one credit data object is listed on an immutable transaction history of the blockchain network as having occurred.

9. The method of claim 1, wherein the credit data object pertains to a tally of points associated with an internal point system of the blockchain network, wherein the internal point system corresponds to transactions effectuated by entities associated with the blockchain network.

10. The method of claim 1, wherein the credit data object pertains to a benefit inured to at least one of the provider, the recommender, and the acquirer.

11. The method of claim 10, wherein the benefit is an allotment of points associated with an internal point system of the blockchain network, wherein the internal point system corresponds to transactions effectuated by entities associated with the blockchain network.

12. The method of claim 10, wherein the benefit is an allocation of preferred access to data resources associated with the blockchain ledger.

13. The method of claim 10, wherein the benefit is apportioned between at least two of the provider, the recommender, and the acquirer.

14. A method for providing a data exchange marketplace through a private blockchain network, the method comprising:
creating a marketing data object in a world state associated with the blockchain network, wherein the marketing data object provides open access on the private blockchain network to details about a data object stored on a database;
adding descriptive data to the marketing data object, the descriptive data received from a first peer associated with a first entity, the descriptive data comprising a first hash of the data object;
receiving a first transaction proposal on the private blockchain network, from a second peer associated with a second entity approved on the private blockchain network, the first transaction proposal comprising a recommendation data object;
receiving an endorsed first transaction proposal response from each of, the first peer associated with the first entity and the second peer associated with the second entity;
adding the recommendation data object to the marketing data object in the world state;
receiving a second transaction proposal on the private blockchain network, from a third peer associated with a third entity approved on the private blockchain network, the second transaction proposal comprising an acquisition data object;
receiving an endorsed second transaction proposal response from each of, the first peer associated with the first entity and the third peer associated with the third entity;
adding the acquisition data object to the marketing data object in the world state;
facilitating possession of a copy of the data object for the third entity, wherein possession is only facilitated after the acquisition data object is added to the world state; and
facilitating validation, by the third entity, that the copy of the data object has a second hash that identically matches the first hash of the data object contained in the marketing data object of the world state.

15. The method of claim 14, further comprising facilitating an operation upon data associated with the data object, wherein manifestation of occurrence the operation upon the data is placed in sequence and added to an immutable transaction history of the blockchain network.

16. The method of claim 15, wherein the operation includes aggregating the data associated with the data object into a nicely formatted set.

17. The method of claim 14, further comprising modifying at least one of a credit data object associated with the first entity, a credit data object associated with the second entity, and a credit data object associated with the third entity.

18. A method for providing a data exchange marketplace through a private blockchain network, the method comprising:
creating a marketing data object in a world state associated with the blockchain network, wherein the marketing data object provides open access on the private blockchain network to details about a data object stored on a database;
adding descriptive data to the marketing data object, the descriptive data received from a peer associated with a provider, the descriptive data comprising a first hash of the data object;
receiving a transaction proposal on the private blockchain network, from a peer associated with an acquirer approved on the private blockchain network, the second transaction proposal comprising an acquisition data object;
receiving an endorsed transaction proposal response from each of, the peer associated with the provider and the peer associated with the acquirer;
adding the acquisition data object to the marketing data object in the world state;
facilitating possession of a copy of the data object for the acquirer, wherein possession is only facilitated after the acquisition data object is added to the world state;
facilitating validation, by the acquirer, that the copy of the data object has a second hash that identically matches the first hash of the data object contained in the marketing data object of the world state; and
modifying at least one of a credit data object associated with the provider and a credit data object associated with the acquirer.

19. The method of claim 18, further comprising:
receiving a transaction proposal on the private blockchain network, from a peer associated with a recommender approved on the private blockchain network, the transaction proposal, from the peer associated with the recommender, including a recommendation data object;
receiving an endorsed transaction proposal response from each of, the peer associated with the provider and the peer associated with the recommender; and
adding the recommendation data object to the marketing data object in the world state.

20. The method of claim 18, wherein the credit data object pertains to a benefit inured to at least one of the provider and the acquirer.
